(19) United States
(12) Patent Application Publication
(10) Pub. No.: US 2008/0102762 A1
(43) Pub. Date: May 1, 2008

(54) Methods and apparatus for a hybrid antenna switching system

(76) Inventors: Lianjun Liu, Chandler, AZ (US); James R. Griffiths, Chandler, AZ (US)

Correspondence Address: INGRASSIA FISHER & LORENZ, P.C. (FS), 7150 E. CAMELBACK ROAD, SUITE 325, SCOTTSDALE, AZ, 85251, US

(21) Appl. No.: 11/590,277

(22) Filed: Oct. 30, 2006

(51) Int. Cl. H04B 1/44

(52) U.S. Cl. 455/78; 455/552.1

(57) ABSTRACT

A hybrid antenna switching system in a communications device generally includes an antenna, a first switching device, and a second switching device. The first switching device is configured to selectively couple the antenna to a first set of communication paths within the communications device, wherein the first set of communication paths includes at least one transmit path associated with a first type of wireless communication standard (e.g., a global system for communication (GSM) standard). The second switching device is configured to selectively couple the antenna to a second set of communication paths within the communications device, wherein the second set of communication paths includes at least one reception path associated with the first type of wireless communication standard. The second switching device is a micro-electromechanic system (MEMS) switch integrated with the first switching device on, for example, a common printed circuit board (PCB) or multi-chip module (MCM) substrate.

### TECHNICAL FIELD

The present invention generally relates to communication systems, and more particularly relates to methods and apparatus for switching between channels in radio antenna systems.

### BACKGROUND

The functionality of cellular telephones and other such portable devices has increased significantly in recent years. As a result, the number of transmission and reception channels (or “paths”) used by such devices has also increased In a typical second generation (“2G”) quad-band cellular telephone, for example, four GSM (Global System for Mobile Communications) bands are incorporated: Cell, DCS (Digital Cellular System), Extended-GSM (EGSM), and PCS (Personal Communications Service). To switch between these various bands, a switch such as a SP6T (single-pole, six-throw) switch is commonly used, which can accommodate two transmit (Tx) ports, and four reception (Rx) ports. For “2.5G” or “3G” telephones that include W-CDMA modulation (Wideband Code Division Multiple Access), a SPnT switch, with n≧8, is commonly used. Such switches are typically PIN (P-type/Intrinsic/N-type) diodes or GaAs PHEMTs (Pseudomorphic High Electron Mobility Transistors). PHEMT devices are generally more popular due to their relatively low power consumption.

Currently known methods for switching between antennas and paths within a cellular device are undesirable in a number of respects. For example, as the number of throws, n, in a common SPnT switch increases, the switch not only becomes larger, but its RF performance degrades. This performance degradation might include insertion loss—i.e., a decrease in transmitted signal power resulting from insertion of the switch in the circuit For example, the Tx insertion loss increases from about 0.5 dB for a SP6T switch to about 0.8 dB-0.9 dB for an SP8T switch. This is equal to a PAE (Power-Added Efficiency) loss of about 3-4%.

Accordingly, it is desirable to provide antenna switching systems that reduce insertion loss at both the Tx and Rx paths while maintaining isolation between the switch ports. Other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the various embodiments may be derived by referring to the detailed description and claims when considered in conjunction with the following figures, wherein like reference numbers refer to similar elements throughout the figures.

FIG. 1 is a conceptual block diagram of a switching system in accordance with one embodiment;

FIG. 2 is a conceptual block diagram of a switching system in accordance with an embodiment incorporating particular types of transmission and reception paths;

FIG. 3 is an isometric view of two switching devices integrated on a single substrate; and

FIG. 4 is a schematic block diagram of multiple MEMS switches arranged in parallel.

### DETAILED DESCRIPTION

The following detailed description is merely illustrative in nature and is not intended to limit the scope or application of possible embodiments. Furthermore, there is no intention to be bound by any expressed or implied theory presented in the preceding technical field, background, brief summary or the following detailed description.

Various embodiments may be described herein in terms of functional and/or logical block components and various processing steps. It should be appreciated that such block components may be realized by any number of hardware, software, and/or firmware components configured to perform the specified functions. For the sake of brevity, conventional techniques and circuitry related to antennas and cellular communication systems have not been described in detail.

In general, two switching devices are integrated (e.g., on a common substrate) to selectively couple an antenna to one of a plurality of communication paths. One switch is a micro-electromechanical system (MEMS) switch that handles reception paths (“Rx” paths) for one type of communication standard (e.g., GSM), while another switch handles the transmission paths (“Tx” paths) for that same type of standard. Thus, the system is a hybrid system, combining MEMS technology with traditional switching device technology.

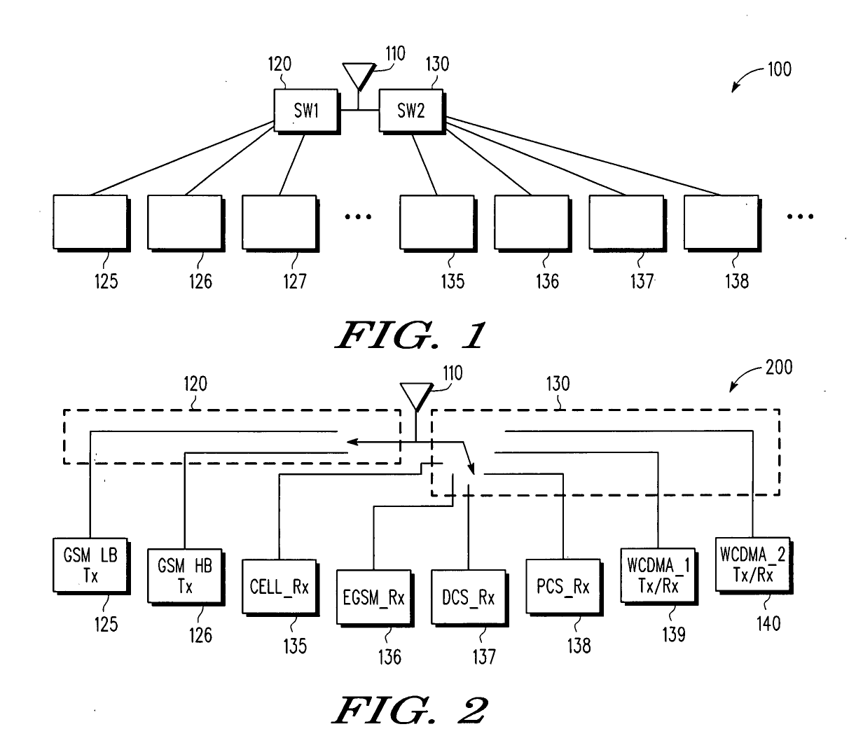

More particularly, referring to FIG. 1, a hybrid antenna switching system 100 in a communications device (not shown) generally includes an antenna 110, a switching device (or “switch”) 120 coupled to antenna 110, and another switching device (or “switch”) 130 also coupled to antenna 110. The illustrated switching system 100 may be incorporated into a variety of cellular devices, including phones, personal data assistants (PDAs), and the like.

Switching device 120 is configured to selectively couple antenna 110 to a first set of communication paths 125-127 within the communications device. Similarly, switching device 130 is configured to selectively couple antenna 110 to a second set of communication paths 135-138. Each set may have any number of paths (or “channels”). At any particular time, however, antenna 110 will be coupled to a single channel within 125-127 or 135-138.

The first set of communication paths 125-127 includes at least one transmit path associated with a particular type of wireless communication standard (e.g., a GSM standard), while the second set of communication paths 135-138 includes at least one reception path associated with that same type of wireless communication standard

In one embodiment, the first and second switching devices 120 and 130 are integrated—e.g., they are formed on and/or within a common substrate, such as a printed circuit board (PCB) substrate or a multi-chip module (MCM) substrate. In a particular embodiment, the second switching device 130 is a micro-electromechanic system (MEMS) switch, and the first switching device 120 is a conventional switch type manufactured using standard (non-MEMS) semiconductor processing techniques—e.g., a pseudomorphic high electron mobility transistor (PHEMT), a PIN (P-type, Intrinsic, N-type) diode, or a silicon-on-sapphire metal-oxide semiconductor field-effect transistor (SOS MOSFET).

The use of the MEMS switch and conventional switch in this way provides high isolation between the Tx and Rx paths. Switching device 120 effectively handles the high power Tx signals (which may be on the order of multiple Watts, at 30-35 dBm), while switching device 130 effectively handles the low power Rx signals (which are typically a mW or less, at less than 0 dBm).

FIG. 2 shows a particular embodiment that incorporates a specific set of GSM transmit and reception paths. More particularly, an antenna 110 is selectively coupled, via switching devices 120 and 130, to respective sets of paths 125-127 and 135-139. Antenna 110 comprises any suitable antenna capable of transmitting and receiving signals as required by the various Rx and Tx paths. A variety of conventional antenna technologies may be used, and thus antenna 110 need not be described in detail herein.

Switching device 130 is a micro-electromechanic system (MEMS) switch, and switching device 120 is a conventional switch type such as a PHEMT, a PIN diode, or a SOS device. In this embodiment, switching device 120 is a SP2T (single-pole, 2-throw) PHEMT switch (e.g., a Sony CXG 1189UR PHEMT SP2T switch, or the equivalent), and switching device 130 is a 6-path MEMS switch having any convenient MEMS structure, as described further below.

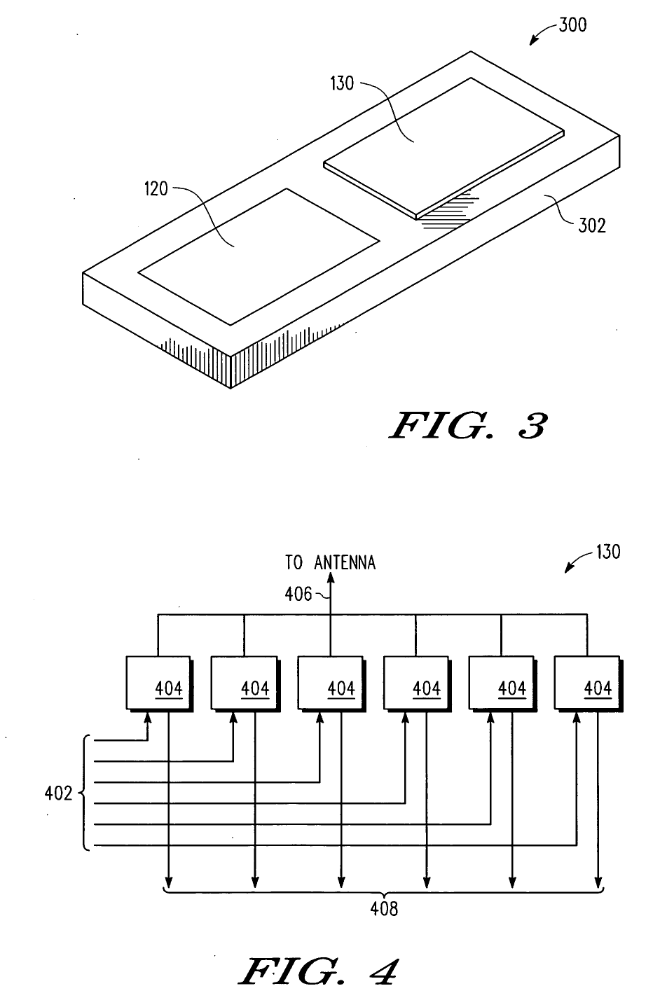

Switching devices 130 and 120 are preferably integrated on a common substrate. Referring to the conceptual diagram shown in FIG. 3, a hybrid switching system 300 includes switching devices 120 and 130 formed on and/or within a common substrate 302. Substrate 302 might be a module, a semiconductor device, a PCB, high-density substrate, or any other substrate now known or later developed. Additional control circuitry, metal interconnects, processors, RF devices, antennas, and the like may also be incorporated into or on substrate 302. For example, conductive traces associated with paths 125-127 and 135-140 are not shown in FIG. 3.

The first set of communication paths 125-126 includes two Tx paths (125 and 126) associated with a particular wireless communication standard—i.e., a GSM low band path 125 and GSM high band path 126. The second set of communication paths 135-140 includes four reception paths associated with various GSM standards—i.e., Cell Rx path 135, EGSM (extended GSM) Rx path 136, DCS Rx path 137, and PCS Rx path 138. While these communication standards are different (GSM, DCS, PCS), they are related, and are of the same “type.” (i.e, GSM). Thus, communication paths 125-126 include two GSM Tx paths, and communication paths 135-140 include four GSM Rx paths. The frequency ranges and power requirements for each of these standards are well known in the art, and need not be described herein.

MEMS switching device 120 may take a variety of forms, but generally includes some form of internal switch structure actuated by an externally-applied voltage that causes an internal electrostatic potential between components of the structure. By adjusting this electrostatic potential, the internal components are actuated to perform the desired switching. Functionally, MEMS switches may take many forms, including single-pole/single-throw (SPST), single-pole/double throw (SPDT), and the like. In one embodiment, as shown in FIG. 4, multiple conventional single-pole, single-throw MEMS switches are used side-by-side. That is, the input 406 (leading to the antenna, not shown) is tied to each of the MEMS switches 404. Each switch 404 has an associated control signal 402 capable of turning the switch “on” and “off.” Multiple outputs 408 (coupled to the various paths 125 and 135 shown in FIG. 2) lead from the set of switches 404. In this way, any number of control paths may be incorporated. The use of MEMS switch technology in this way provides low insertion loss, high-isolation, and high linearity.

Referring again to FIG. 2, in accordance with the illustrated embodiment, switch 130 is also capable of selecting paths associated with two W-CDMA (Wideband Code Division Multiple Access) paths 139 and 140. Each of these two paths include Rx and Tx channels. Any number of additional paths may be included and coupled to switch 130. Similarly, switching device 120 is not limited to two paths as illustrated.

In summary, what has been described is a hybrid antenna switching system in a communications device comprising a first switching device configured to selectively couple an antenna to a first set of communication paths within the communications device, wherein the first set of communication paths includes at least one transmit path associated with a first type of wireless communication standard; and a second switching device configured to selectively couple the antenna to a second set of communication paths within the communications device, wherein the second set of communication paths includes at least one reception path associated with the first type of wireless communication standard, wherein the second switching device is a micro-electromechanic system (MEMS) switch integrated with the first switching device.

In one embodiment, the first switching device is selected from the group consisting of a pseudomorphic high electron mobility transistor (PHEMT), a PIN (p-type, intrinsic, n-type) diode, and a silicon-on-sapphire metal-oxide semiconductor field-effect transistor (SOS MOSFET).

The first type of wireless communication standard may be a global system for mobile communications (GSM) type of standard. The at least one transmission path within the first set of communication paths may include a GSM low-band transmission path and a GSM high-band transmission path. The at least one reception path within the second set of communication paths may include an extended-GSM (EGSM) reception path, a digital cellular system (DCS) reception path, a personal communications service (PCS) reception path, and a cell reception path. In another embodiment, the second set of communication paths includes at least one wideband code division multiple access (W-CDMA) reception path and at least one W-CDMA transmit path. In a particular embodiment, the first switching device is a single-pole 2-throw (SP2T) switch.

In accordance with another embodiment, a hybrid antenna switching system in a communications device comprises: a substrate; an antenna; a first switching device formed on the substrate, the first switching device configured to selectively couple the antenna to a first set of communication paths within the communications device, wherein the first set of communication paths includes at least one transmit path associated with a global system for mobile communication (GSM) wireless communication standard; and a second switching device formed on the substrate, the second switching device configured to selectively couple the antenna to a second set of communication paths within the communications device, wherein the second set of communication paths includes at least one reception path associated with the GSM wireless communication standard, wherein the second switching device is a micro-electromechanic system (MEMS) switch integrated with the first switching device.

In one embodiment, the substrate comprises a printed circuit board (PCB) substrate. In another, the substrate comprises a multi-chip module (MCM). In a particular embodiment, the first switching device is selected from the group consisting of a pseudomorphic high electron mobility transistor (PHEMT), a P-I-N (p-type, intrinsic, n-type) diode, and a silicon-on-sapphire metal-oxide semiconductor field-effect transistor (SOS MOSFET). The at least one transmission path within the first set of communication paths may include a GSM low-band transmission path and a GSM high-band transmission path. The at least one reception path within the second set of communication paths may include an extended-GSM (EGSM) reception path, a digital cellular system (DCS) reception path, a personal communications service (PCS) reception path, and a cell reception path. The second set of communication paths may include at least one wideband code division multiple access (W-CDMA) reception path and at least one W-CDMA transmit path. The first switching device may be, for example, a single-pole 2-throw (SP2T) switch.

In accordance with another embodiment, a method for selectively coupling an antenna to a plurality of communication paths within a communication device includes: providing a micro-electromechanic system (MEMS) switching device configured to selectively couple the antenna to a first set of the communication paths within the communications device; providing a second switching device integrated with the MEMS switching device, the second switching device configured to selectively couple the antenna to a second set of communication paths within the communications device; coupling the antenna to a transmit path associated with a first type of wireless communication standard, wherein the first switching device is a micro-electromechanic system (MEMS) switch; and coupling the antenna to the second set of communication paths, wherein the second set of communication paths includes at least one reception path associated with the first type of wireless communication standard

In one embodiment, the step of providing the second includes providing a switching device selected from the group consisting of a pseudomorphic high electron mobility transistor (PHEMT), a P-I-N (p-type, intrinsic, n-type) diode, and a silicon-on-sapphire metal-oxide semiconductor field-effect transistor (SOS MOSFET). In one embodiment, the first type of wireless communication standard is a global system for mobile communications (GSM) type of standard. The first set of communication paths may include a GSM low-band transmission path and a GSM high-band transmission path. The at least one reception path within the second set of communication paths includes an extended-GSM (EGSM) reception path, a digital cellular system (DCS) reception path, a personal communications service (PCS) reception path, and a cell reception path.

While at least one example embodiment has been presented in the foregoing detailed description, it should be appreciated that a vast number of variations exist. It should also be appreciated that the example embodiment or embodiments described herein are not intended to limit the scope, applicability, or configuration of the various embodiments in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A switching system for a communications device, the switching system comprising:
a first switching device configured to selectively couple an antenna to a first set of communication paths within the communications device, wherein the first set of communication paths includes at least one transmit path associated with a first type of wireless communication standard; and
a second switching device configured to selectively couple the antenna to a second set of communication paths within the communications device, wherein the second set of communication paths includes at least one reception path associated with the first type of wireless communication standard, wherein the second switching device is a micro-electromechanic system (MEMS) switch integrated with the first switching device.

2. The switching system of claim 1, wherein the first switching device is selected from the group consisting of a pseudomorphic high electron mobility transistor (PHEMT), a PIN (p-type, intrinsic, n-type) diode, and a silicon-on-sapphire metal-oxide semiconductor field-effect transistor (SOS MOSFET).

3. The switching system of claim 1, wherein the first type of wireless communication standard is a global system for mobile communications (GSM) type of standard.

4. The switching system of claim 3, wherein the at least one transmission path within the first set of communication paths includes a GSM low-band transmission path and a GSM high-band transmission path.

5. The switching system of claim 3, wherein the at least one reception path within the second set of communication paths includes an extended-GSM (EGSM) reception path, a digital cellular system (DCS) reception path, a personal communications service (PCS) reception path, and a cell reception path.

6. The switching system of claim 3, wherein the second set of communication paths includes at least one wideband code division multiple access (W-CDMA) reception path and at least one W-CDMA transmit path.

7. The switching system of claim 1, wherein the first switching device is a single-pole 2-throw (SP2T) switch.

8. A hybrid antenna switching system in a communications device, the switching system comprising:
a substrate;
a first switching device formed on the substrate, the first switching device configured to selectively couple an antenna to a first set of communication paths within the communications device, wherein the first set of communication paths includes at least one transmit path associated with a global system for a wireless communication standard; and
a second switching device formed on the substrate, the second switching device configured to selectively couple the antenna to a second set of communication paths within the communications device, wherein the second set of communication paths includes at least one reception path associated with the wireless communication standard, wherein the second switching device is a micro-electromechanic system (MEMS) switch integrated with the first switching device.

9. The switching system of claim 8, wherein the substrate comprises a printed circuit board (PCB) substrate.

10. The switching system of claim 8, wherein the substrate comprises a multi-chip module (MCM).

11. The switching system of claim 8, wherein the first switching device is selected from the group consisting of a pseudomorphic high electron mobility transistor (PHEMT), a P-I-N (p-type, intrinsic, n-type) diode, and a silicon-on-sapphire metal-oxide semiconductor field-effect transistor (SOS MOSFET).

12. The switching system of claim 8, wherein the at least one transmission path within the first set of communication paths includes a GSM low-band transmission path and a GSM high-band transmission path.

13. The switching system of claim 8, wherein the at least one reception path within the second set of communication paths includes an extended-GSM (EGSM) reception path, a digital cellular system (DCS) reception path, a personal communications service (PCS) reception path, and a cell reception path.

14. The switching system of claim 8, wherein the second set of communication paths further includes at least one wideband code division multiple access (W-CDMA) reception path and at least one W-CDMA transmit path.

15. The switching system of claim 8, wherein the first switching device is a single-pole 2-throw (SP2T) switch.

16. A method for selectively coupling an antenna to a plurality of communication paths within a communication device, the method comprising:
providing a micro-electromechanic system (MEMS) switching device configured to selectively couple the antenna to a first set of the communication paths within the communications device;
providing a second switching device, the second switching device integrated with the MEMS switching device, the second switching device configured to selectively couple the antenna to a second set of communication paths within the communications device;
coupling the antenna to a transmit path associated with a first type of wireless communication standard, wherein the first switching device is a micro-electromechanic system (MEMS) switch; and
coupling the antenna to the second set of communication paths, wherein the second set of communication paths includes at least one reception path associated with the first type of wireless communication standard.

17. The method of claim 16, wherein providing the second switching device includes providing a switching device selected from the group consisting of a pseudomorphic high electron mobility transistor (PHEMT), a P-I-N (p-type, intrinsic, n-type) diode, and a silicon-on-sapphire metal-oxide semiconductor field-effect transistor (SOS MOSFET).

18. The method of claim 16, wherein the first type of wireless communication standard is a global system for mobile communications (GSM) type of standard.

19. The method of claim 16, wherein the at least one transmission path within the first set of communication paths includes a GSM low-band transmission path and a GSM high-band transmission path.

20. The method of claim 16, wherein the at least one reception path within the second set of communication paths includes an extended-GSM (EGSM) reception path, a digital cellular system (DCS) reception path, a personal communications service (PCS) reception path, and a cell reception path.
